(19) United States
(12) Patent Application Publication
(10) Pub. No.: US 2012/0265469 A1
(43) Pub. Date: Oct. 18, 2012

(54) CALIBRATION METHOD AND DEVICE

(75) Inventors: SHENG-HUEI YANG, NEW TAIPEI CITY (TW); CHING-FENG HSIEH, TAIPEI CITY (TW)

(73) Assignee: ASKEY COMPUTER CORP., NEW TAIPEI CITY (TW)

(21) Appl. No.: 13/157,437

(22) Filed: Jun. 10, 2011

(30) Foreign Application Priority Data
Apr. 15, 2011 (TW) 100113182

(51) Int. Cl. G06F 19/00

(52) U.S. Cl. 702/85

(57) ABSTRACT

A calibration method and device calibrate a signal to be calibrated and measured. The signal to be calibrated and measured is outputted by a linear measurement system in a test stage. The method includes inputting a default input signal to the linear measurement system to obtain a default measurement signal; determining a linear strength between the default measurement signal and the default input signal; obtaining a calibration formula according to linear retrogression to calibrate the signal to be calibrated and measured, thereby obtaining a calibrated value and effectuating precise linear measurement.

### CROSS-REFERENCE TO RELATED APPLICATION

This non-provisional application claims priority under 35 U.S.C. §119(a) on Patent Application No(s). 100113182 filed in Taiwan, R.O.C. on Apr. 15, 2011, the entire contents of which are hereby incorporated by reference.

### FIELD OF TECHNOLOGY

The present invention relates to calibration methods and devices, and more particularly, to a method and device for calibrating a linear measurement system quickly.

### BACKGROUND

According to the prior art, a linear measurement system performs a linear measurement process on physical parameters, such as voltage, current, or temperature. However, linear errors are inherently produced by components of the linear measurement system (because of the aging of the components, for example). Linear errors are also produced as a result of the interaction of the components of the linear measurement system. The aforesaid errors accumulate and thereby affect the overall linear errors of the linear measurement system, thereby compromising the accuracy of the measurement of the linear measurement system.

In general, the linear strength between an input end and an output end of the linear measurement system is measured by a test meter (such as an oscilloscope and a multimeter). When sufficient linear strength is detected, it indicates that the linear errors produced by the linear measurement system can be calibrated by hardware (such as additional resistors, capacitors, and inductors) such that the calibrated linear measurement system restores the accuracy required for measurement. Conversely, when insufficient linear strength is detected, it indicates that the linear measurement system cannot be calibrated by the aforesaid hardware in order to calibrate the linear errors, thereby rendering the linear measurement system useless.

However, a test of the linear strength requires performing an inputting operation and an outputting operation on the components one by one with a test meter; in doing so, it is time-consuming and laborious to perform a linear test on the components of a linear measurement system having plenty of components in order to evaluate the linear strength therebetween, not to mention that a large number of such components render any analysis thereof difficult. In the scenario where the linear strength is large enough to be calibrated by hardware, hardware requirements for calibration increase with the scale of the linear measurement system (for example, a linear measurement system that comprises multistage linear circuits). In turn, the increase in the hardware requirements for calibration not only incurs additional costs of the linear measurement system but also causes difficulty in the maintenance of the linear measurement system.

Accordingly, it is imperative to provide a method and device for calibrating a linear measurement system in a quick, time-saving, labor-saving, and accurate manner and in a way effective in overcoming the aforesaid drawbacks of the prior art.

### SUMMARY

It is an objective of the present invention to provide a calibration device for optimizing (that is, minimizing the square of an error of) an input/output linear relationship with a specific linear strength of a linear measurement system.

Another objective of the present invention is to provide a calibration method for calibrating a linear measurement system flawed with linear errors such that the linear measurement system measures an input signal source precisely and accurately.

In order to achieve the above and other objectives, the present invention provides a device for calibrating a measurement signal outputted by a linear measurement system. The device comprises: a measurement signal input unit connected to the linear measurement system for receiving the measurement signal; a default input signal input unit for receiving the input signal; and a control unit connected to the measurement signal input unit and the default input signal input unit, the control unit adapted to determine a linear strength between the input signal and the measurement signal to obtain a equation of the line for a calibration formula and use the obtained the equation of the line as a calibration formula when the linear strength falls within the default range in the initialization stage and calibrate the measurement signal with the calibration formula in the test stage.

In order to achieve the above and other objectives, the present invention provides a method for calibrating a calibrating measurement signal outputted by a linear measurement system receiving a testing input signal, the method comprising the steps of: outputting a default measurement signal from the linear measurement system based on receiving a default input signal; determining a linear strength between the default measurement signal and the default input signal; creating a equation of the line for a calibration formula by selective application of a linear retrogression from the default measurement signal and the default input signal based on the linear strength; and substituting the measurement signal detected by the linear measurement system into the calibration formula so as to perform calibration.

Unlike the prior art, the present invention provides a calibration method and device for determining a linear strength between a default input signal and a default measurement signal of the linear measurement system, and then determining whether to calibrate the linear measurement system according to the linear strength level. For example, if the linear strength falls within the default range (that is, approximating to positive correlation or negative correlation, for example), it can be determined that the linear measurement system can be calibrated to effectuate precise measurement. Conversely, if the linear strength falls outside the default range (distancing from positive correlation or negative correlation, for example), it can be determined that the linear measurement system is unfit to effectuate precise measurement even when calibrated, and thus it is not necessary to calibrate the linear measurement system, so as to dispense with a time-consuming process of calibration and circuit debug.

Furthermore, in the situation where a jig at a production line is a linear measurement system, it is feasible for the calibration method and device of the present invention to determine whether the linear strength of the jig falls within the default range, calibrate the jig in response to an affirmative determination, and see the jig as unfit for use in response to a negative determination.

A calibration method and device of the present invention improves a linear strength when the jig is used in linear measurement. Enhancement of the linear strength is conducive to enhancement of the precision of measurement of products on a production line. Accordingly, according to the present invention, the determination as to whether to calibrate a linear measurement system can be made in a quick, time-saving, labor-saving, and accurate manner, so is the calibration of the linear measurement system.

### BRIEF DESCRIPTION OF THE DRAWINGS

Objectives, features, and advantages of the present invention are hereunder illustrated with specific embodiments in conjunction with the accompanying drawings, in which:

FIG. 1 is a flow chart of a calibration method according to an embodiment of the present invention;

FIG. 2 is a block diagram of a calibration device according to an embodiment of the present invention;

FIG. 3 is a schematic view of the linear relationship of a measurement system shown in FIG. 2;

FIG. 4 is a schematic view of the linear relationship of the measurement system shown in FIG. 2; and

FIG. 5 is a schematic view of the calibrated linear relationship of the measurement system shown in FIG. 3.

### DETAILED DESCRIPTION

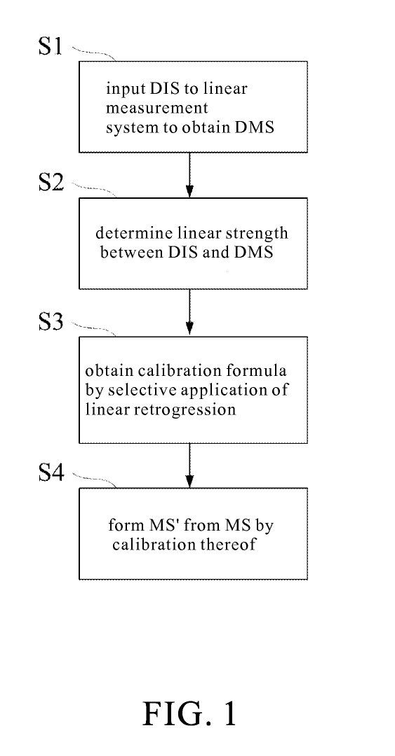

Referring to FIG. 1, there is shown a flow chart of a calibration method according to an embodiment of the present invention. As shown in FIG. 1, the calibration method calibrates a linear measurement system for measuring an input signal. For example, the linear measurement system is a device, an apparatus, or a meter for measuring a signal source, such as a voltage source or a current source.

The calibration method is performed in two stages, namely an initialization stage and a test stage. The initialization stage involves setting a calibration formula. The test stage involves testing a linear measurement system in a manner that the linear measurement system outputs a signal to be calibrated and measured and is calibrated by a calibration formula.

Step S1 of the calibration method starts with the initialization stage which involves inputting a default input signal to the linear measurement system, and obtaining an outputted default measurement signal, wherein the default measurement signal is obtained as a result of the linear conversion of the default input signal into the default measurement signal by the linear measurement system. The default input signal is linearly converted into a measurement value. For example, the default input signal is an incoming physical parameter, such as a voltage source, a current source, temperature, or humidity. For instance, a measurement value can be generated by a linear circuit of the linear measurement system according to the default measurement signal. The linear circuit is at least one of a sensing circuit, a linear operational circuit, and an analog-to-digital conversion circuit, and is adapted to perform amplification, rectification, attenuation, or conversion of the default input signal.

Step S2 involves determining a linear strength between the default measurement signal and the default input signal according to a correlation coefficient, that is, determining whether the linear strength falls within a default range. For example, the default range is defined as the normalized linear strength that ranges between 0.95 and 1 or ranges between −0.95 and −1. However, the aforesaid range is illustrative, rather than restrictive, of the present invention, and should be seen as a reasonable expected range of a required measurement.

In the aforesaid embodiment, when the linear strength approximates to 1 (also known as positively correlated) or −1 (also known as negatively correlated) (for example, either “−1<normalized linear strength≦−0.95” or “0.95≦normalized linear strength<1” indicates a well-defined linear relationship between the input and output of the linear measurement system, and thus it is feasible to calibrate the output of the linear measurement system (that is, a measured value of a linear system) by linear retrogression (described below) so as to optimize the linear relationship of the linear measurement system and enable the linear measurement system to provide accurate linear measurement. Conversely, when the linear strength distances itself from 1 or −1, (for example when −0.95<normalized linear strength<0.95), it indicates that the linear measurement system provides an ill-defined linear relationship and thus unable to effectuate accurate linear measurement by calibration. When the linear strength equals 1 or −1, it indicates that the linear measurement system is precise and thus does not require calibration. Hence, when the normalized linear strength is equal 1 or −1, or less than 0.95 but larger than −0.95, it is not necessary to create the equation of the line for use as a calibration formula.

The discriminant of the linear strength is as follows:

(Σ(x−\dot{x})(y−\dot{y}))/(\sqrt{Σ(x−\dot{x})²}\sqrt{Σ(y−\dot{y})²}), wherein \dot{x}=Σᵢ₌₁ⁿxᵢ/n; \dot{y}=Σᵢ₌₁ⁿyᵢ/n,

where the value of the default input signal received by the linear measurement system and the value of the default measurement signal outputted by the linear measurement system are denoted by x and y, respectively, the averages of x and y are denoted by \dot{x} and \dot{y}, respectively, and n denotes a natural number.

Step S3 involves creating a equation of the line formula from the default measurement signal and the default input signal according to the linear strength and by selective application of linear retrogression method (also known as the least square method), followed by using the equation of the line as the calibration formula. The equation of the line has parameters, such as a slope and a level. Hence, when the linear strength is positive correlation or negative correlation or approximates to positive correlation or negative correlation, the present invention further determines the calibration formula of the linear measurement system, and an error-stricken signal to be calibrated and measured (i.e., an error-stricken measurement signal) can be calibrated with the calibration formula such that it approximates or equals an accurately measured value of an input signal. The calibration formula is z=my′+l, wherein a slope, a level, a value of the measurement signal outputted by the linear measurement system, and the calibrated measurement value are denoted by m, l, y′, and z, respectively. The slope and the level are expressed, respectively, by:

m=nΣᵢ₌₁ⁿxᵢyᵢ−Σᵢ₌₁ⁿxᵢΣᵢ₌₁ⁿyᵢ/n)/(nΣᵢ₌₁ⁿxᵢ²−(Σᵢ₌₁ⁿxᵢ)²);

l=\dot{y}−m\dot{x}

wherein the slope and the level are denoted by m and l, respectively, the default input signal value and the default measurement signal value are denoted by x and y, respectively, and the averages of x and y are denoted by \dot{x} and \dot{y}, respectively.

Step S4 starts with the test stage and involves treating an input signal inputted to the linear measurement system as the signal to be calibrated and measured (hereinafter referred to as the measurement signal), substituting the measurement signal into the calibration formula for calibration, and obtaining a calibrated value, thereby effectuating precise linear measurement.

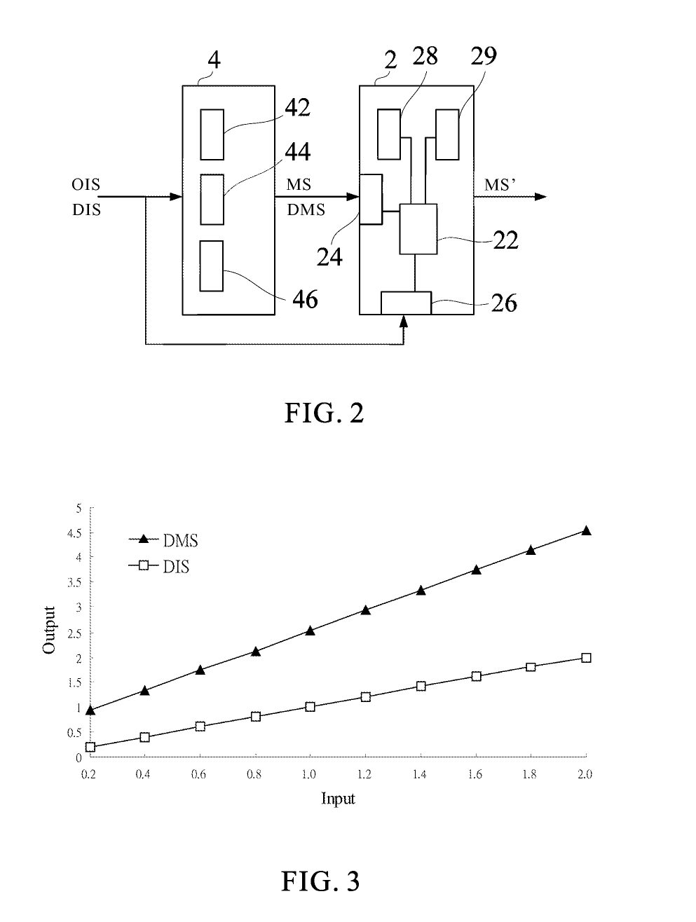

Referring to FIG. 2, there is shown a block diagram of a calibration device according to an embodiment of the present invention. As shown in FIG. 2, the calibration device 2 is for calibrating a signal to be calibrated and measured (hereinafter referred to as a measurement signal) MS in a linear measurement system 4. In the test stage, the linear measurement system 4 converts an input signal OIS into a measurement value, that is, the measurement signal MS. The measurement signal MS enters the calibration device 2 via a measurement signal input unit 24 thereof. Afterward, the measurement signal MS is calibrated to become a calibrated and measured signal MS′. For instance, the linear measurement system 4 comprises a sensing circuit 42 (such as a voltage sensor), a linear operational circuit 44 (such as an operational amplifier), and an analog-to-digital conversion circuit 46 (such as an analog-to-digital converter), though the present invention is not limited thereto. The analog sensing (or known as measurement) of the input signal OIS is performed by the sensing circuit 42. Then, the input signal OIS thus sensed is amplified or attenuated by the linear operational circuit 44. Finally, the analog-to-digital conversion circuit 46 performs an analog-to-digital conversion process on the input signal OIS thus amplified or attenuated so as to generate a digital measurement value therefrom.

The calibration device 2 comprises the measurement signal input unit 24, a default input signal input unit 26, and a control unit 22. The measurement signal input unit 24 is connected to the linear measurement system 4 and adapted to receive the measurement signal MS or a default measurement signal DMS. In the initialization stage, the linear measurement system 4 outputs the default measurement signal DMS according to an incoming default input signal DIS. The default input signal input unit 26 receives the default input signal DIS.

The control unit 22 is connected to the measurement signal input unit 24 and the default input signal input unit 26. In the initialization stage, the control unit 22 determines a linear strength between the received default input signal DIS and the received default measurement signal DMS to obtain a equation of the line between the default input signal DIS and the default measurement signal DMS whenever the linear strength falls inside the default range so as to treat the equation of the line as a calibration formula. Afterward, in the test stage, the control unit 22 converts the measurement signal MS into the calibrated and measured signal MS' by calibration thereof with the calibration formula. The calibrated and measured signal MS′ approximates or equals the input signal OIS corresponding to the measurement signal MS.

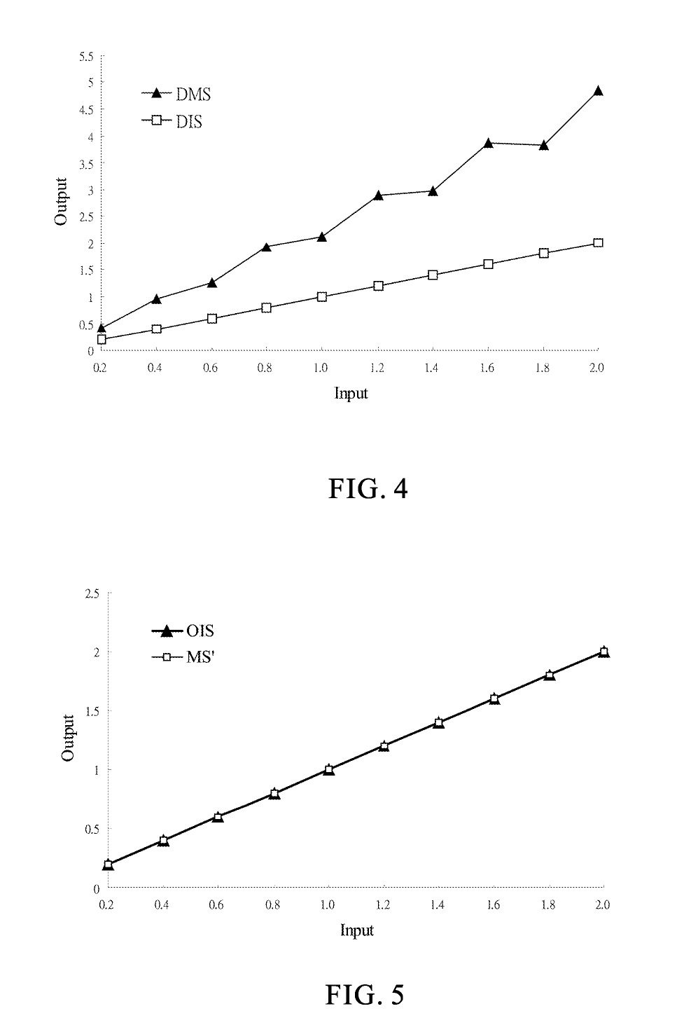

Furthermore, the control unit 22 further comprises at least one of a memory unit 28 and a display unit 29. The memory unit 28 stores the calibration formula. The display unit 29 displays a linear strength between the default input signal DIS and the default measurement signal DMS. The linear strength demonstrates the linear relationship between the default input signal DIS and the default measurement signal DMS. In this regard, a well-defined linear relationship is depicted by FIG. 3, and an ill-defined linear relationship is depicted by FIG. 4. Referring to FIG. 3, when the value of the default input signal DIS equals 0.2, the value of the default measurement signal DMS measured by the linear measurement system 4 equals 1 approximately. Likewise, as shown in FIG. 3, when the value of the default input signal DIS equals 1, the value of the default measurement signal DMS measured by the linear measurement system 4 equals 2.5 approximately. Referring to FIG. 4, an ill-defined linear strength falls with the range of −0.95˜+0.95, thereby indicating that the linear measurement system has become unfit to operate, as it is no longer possible for the linear measurement system to perform its measurement function by means of calibration.

FIG. 5 is a schematic view of the calibrated linear relationship of the measurement system shown in FIG. 3, indicating that the calibration enhances the precision of the linear measurement system 4, as substantiated in FIG. 5 which shows that the value of the calibrated and measured signal MS' coincides with the value of the input signal OIS.

Hence, optimal calibration of a well-defined linear relationship can be achieved by the aforesaid correlation coefficient and linear retrogression. By contrast, it is impossible to perform optimal calibration on an ill-defined linear relationship because of an excessive error of an internal electronic component. In this regard, the present invention has an advantage: the method and device for calibrating a linear measurement system according to the present invention are effective in identifying an error-stricken component of the linear measurement system and thereby rejecting the error-stricken linear measurement system.

Unlike the prior art, the present invention provides a calibration method and device for determining a linear strength between the default input signal DIS and the default measurement signal DMS of the linear measurement system, and then determining whether to calibrate the linear measurement system according to the linear strength level. For example, if the linear strength falls within the default range (that is, approximating to positive correlation or negative correlation, for example), it can be determined that the linear measurement system can be calibrated to effectuate precise measurement. Conversely, if the linear strength falls outside the default range (distancing from positive correlation or negative correlation, for example), it can be determined that the linear measurement system is unfit to effectuate precise measurement even when calibrated, and thus it is not necessary to calibrate the linear measurement system, so as to dispense with a time-consuming process of calibration and circuit debug.

Furthermore, in the situation where a jig at a production line is a linear measurement system, it is feasible for the calibration method and device of the present invention to determine whether the linear strength of the jig falls within the default range, calibrate the jig in response to an affirmative determination, and see the jig as unfit for use in response to a negative determination. In doing so, with the calibration method and device of the present invention, it is quick, time-saving, labor-saving, and precise to perform a calibration process on a product being manufactured at a production line and being designed to function as a linear measurement system.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the embodiments should fall within the scope of the present invention which should be defined by the appended claims.

What is claimed is:

1. A device for calibrating a measurement signal outputted by a linear measurement system receiving an input signal, the device comprising:
a measurement signal input unit connected to the linear measurement system for receiving the measurement signal;
a default input signal input unit for receiving the input signal; and
a control unit connected to the measurement signal input unit and the default input signal input unit, the control unit adapted to determine a linear strength between the input signal and the measurement signal to obtain a equation of the line for a calibration formula and to calibrate the measurement signal based on the calibration formula.

2. The device of claim 1, wherein the input signal is at least one of a voltage source and a current source.

3. The device of claim 2, wherein the control unit further comprises at least one of a memory unit for storing the calibration formula and a display unit for displaying a value of the linear strength.

4. The device of claim 1 wherein the measurement signal is at least one of a calibrating measurement signal and a default measurement signal, and the input signal is at least one of a testing input signal and a default measurement signal.

5. A method for calibrating a calibrating measurement signal outputted by a linear measurement system receiving a testing input signal, the method comprising the steps of:
outputting a default measurement signal from the linear measurement system based on receiving a default input signal;
determining a linear strength between the default measurement signal and the default input signal;
creating a equation of the line for a calibration formula by selective application of a linear retrogression from the default measurement signal and the default input signal based on the linear strength; and
substituting the signal detected by the linear measurement system and intended to be calibrated and measured into the calibration formula so as to perform calibration.

6. The method of claim 5, wherein the step of selective application of linear retrogression further comprises:
creating the equation of the line whenever the normalized linear strength is larger than or equal to 0.95 but less than 1, or is larger than or equal to −0.95 but less than −1; and
not creating the equation of the line whenever the normalized linear strength is equal to 1 or −1, or is less than 0.95 but larger than −0.95.

7. The method of claim 5, wherein the discriminant of the linear strength is: (Σ(x−\dot{x})(y−\dot{y}))/(\sqrt{Σ(x−\dot{x})²}{square root over (Σ(y−\dot{y})²))}, wherein the default input signal value and the default measurement signal value are denoted by x, and y, respectively, and the averages of x and y are denoted by \dot{x} and \dot{y}, respectively.

8. The method of claim 5, wherein the linear retrogression formula is: z=my′+l, wherein a slope, a level, a value of the signal to be calibrated and measured, and the calibrated value are denoted by m, l, y′, and z, respectively.

9. The method of claim 8, wherein the slope m and the level l are expressed by m=(nΣᵢ₌₁ⁿxᵢyᵢ−Σᵢ₌₁ⁿxᵢΣᵢ₌₁ⁿyᵢ)/(nΣᵢ₌₁ⁿxᵢ²−(Σᵢ₌₁ⁿxᵢ)²) and l=\dot{y}−m\dot{x}, respectively, wherein the default input signal value and the default measurement signal value are denoted by x and y, respectively, and the averages of x and y are denoted by \dot{x} and \dot{y}, respectively.
